(19) United States
(12) Patent Application Publication
(10) Pub. No.: US 2023/0208821 A1
(43) Pub. Date: Jun. 29, 2023

(54) METHOD AND DEVICE FOR PROTECTING AND MANAGING KEYS

(71) Applicant: Nuvoton Technology Corporation, Hsinchu Science Park (TW)

(72) Inventors: Kun-Yi WU, Tainan City (TW); Yu-Shan LI, Tainan City (TW)

(21) Appl. No.: 18/084,759

(22) Filed: Dec. 20, 2022

(30) Foreign Application Priority Data
Dec. 29, 2021 (TW) 110149363

(51) Int. Cl. H04L 9/40

(52) U.S. Cl. CPC H04L 63/0435

(57) ABSTRACT

A method for protecting and managing keys is provided. The method includes the following steps. An OTF cipher transmits a request message to a cryptographic engine to request that the cryptographic engine obtain a wrap key when a key is located in an external memory. The cryptographic engine requests the wrap key from a key store. The key store reads and transmits the wrap key to the cryptographic engine. The OTF cipher requests access to a protection key from the key store, and the key store requests that an external memory controller read the protection key from the external memory. The external memory transmits the protection key to the cryptographic engine. The cryptographic engine generates the key according to the wrap key and the protection key and transmits the key to the OTF cipher. The OTF cipher uses the key to perform an encryption and decryption process.

### CROSS REFERENCE TO RELATED APPLICATIONS

This application claims priority from Taiwan Patent Application No. 110149363, filed on Dec. 29, 2021, the disclosure of which is incorporated herein in its entirety by reference.

### BACKGROUND

### Field of the Application

The present disclosure generally relates to a method and device for protecting and managing keys. More specifically, aspects of the present disclosure relate to a method and device for protecting and managing keys stored in external memory.

### Description of the Related Art

Since the content of data stored in the external memory of current computer systems and control systems is easy to steal, important confidential data needs to be encrypted and protected.

A common encryption architecture is to use a cryptographic engine to encrypt important data (or plaintext) into ciphertext, and then transmit the ciphertext to the external memory through the external memory controller. The Advanced Encryption Standard Counter (AES CTR) cipher mode is most often used to achieve the goal of on-the-fly decryption. However, when the key is stored in the external memory, how to ensure that the key and important data are not stolen by means of encryption, and how to decrypt the key and important data securely in the chip system is still a problem to be solved at present.

Therefore, there is a need for a method and device for protecting and managing keys, so as to achieve the purpose of quickly and effectively protecting important confidential information in the external memory.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and device for protecting and managing keys are provided to achieve the purpose of quickly and effectively protecting important confidential information in the external memory.

In an exemplary embodiment, a method for protecting and managing keys is provided. The method used in a device and comprises the following steps. An on-the-fly (OTF) cipher transmits a request message to a cryptographic engine to request that the cryptographic engine obtain a wrap key when a key is located in an external memory. The cryptographic engine requests the wrap key from a key store. The key store reads the wrap key from an internal memory and transmits the wrap key to the cryptographic engine. The OTF cipher requests access to a protection key from the key store according to key storage information, and the key store requests that an external memory controller read the protection key from the external memory. The external memory transmits the protection key to the cryptographic engine through the key store and the OTF cipher. The cryptographic engine generates the key according to the wrap key and the protection key and transmits the key to the OTF cipher. The OTF cipher uses the key to perform an encryption and decryption process.

In some embodiment, the method further comprises the following steps. The OTF cipher requests access to the key from the key store according to the key storage information when the key is not located in the external memory but is located in the internal memory. The key store reads the key from the internal memory, and transmits the key to the OTF cipher, so that the OTF cipher uses the key to perform the encryption and decryption process.

In some embodiment, the method further comprises the following steps. The OTF cipher requests that the cryptographic engine generate a key stream according to the key. The cryptographic engine generates the key stream according to the key and transmits the key stream to the OTF cipher. The OTF cipher transmits the key stream to the external memory controller.

In some embodiment, the method further comprises the following steps. The external memory controller encrypts data using the key stream to generate encrypted data when the external memory controller receives an encrypted signal. The external memory controller stores the encrypted data in the external memory.

In some embodiment, the external memory, the OTF cipher, the cryptographic engine, the external memory controller, and the key store communicate with each other through sideband signals

In an exemplary embodiment, a device for protecting and managing keys is provided. The device comprises an external memory controller comprising an on-the-fly (OTF) cipher, a cryptographic engine, a key store, and an internal memory. The key store is coupled to the external memory controller and the cryptographic engine. The internal memory is coupled to the key store. When a key is located in an external memory, the OTF cipher transmits a request message to the cryptographic engine to request that the cryptographic engine obtain a wrap key. The cryptographic engine requests the wrap key from the key store. The key store reads the wrap key from the internal memory and transmits the wrap key to the cryptographic engine. The OTF cipher requests access to a protection key from the key store according to key storage information, and the key store requests that the external memory controller read the protection key from the external memory. The external memory transmits the protection key to the cryptographic engine through the key store and the OTF cipher. The cryptographic engine generates the key according to the wrap key and the protection key and transmits the key to the OTF cipher. The OTF cipher uses the key to perform an encryption and decryption process.

### BRIEF DESCRIPTION OF DRAWINGS

The application can be more fully understood by reading the subsequent detailed description and examples with references made to the accompanying drawings, wherein:

FIG. 1 is a schematic diagram illustrating a system for protecting and managing keys according to an embodiment of the present disclosure.

FIG. 2 is a schematic diagram of protection areas according to an embodiment of the present disclosure with reference to FIG. 1.

FIG. 3 is a schematic diagram illustrating a key block structure and a wrap key block structure according to an embodiment of the present disclosure.

FIG. 4 is another functional block diagram showing a partial OTP structure of the system for protecting and managing keys according to an embodiment of the present disclosure.

FIG. 5 shows a flowchart of a method for protecting and managing keys according to an embodiment of the present disclosure.

FIGS. 6A-6B show a flowchart of a method for protecting and managing keys according to an embodiment of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

In particular, the exemplary hardware systems, components, and related methods described below may be supported by techniques including Taiwan Patent Application No. 108132363 “KEY MANAGEMENT DEVICE AND PROCESSOR CHIP FOR DATA ENCRYPTION/DECRYPTION”; Taiwan Patent Application No. 108132364 “KEY MANAGEMENT DEVICE HAVING BYPASS CHANNELS AND PROCESSOR CHIP”; Taiwan Patent Application No. 108132367 “MEMORY CONTROLLER AND DATA PROTECTION METHOD”; and NSIT 800-38F “Recommendation for Block Cipher Modes of Operation: Methods for Key Wrapping”. The patents and documents listed above are incorporated herein by reference and form a part of this specification.

A method and device for protecting and managing keys are provided in the embodiments of the present disclosure to achieve the purpose of quickly and effectively protecting important confidential information in the external memory.

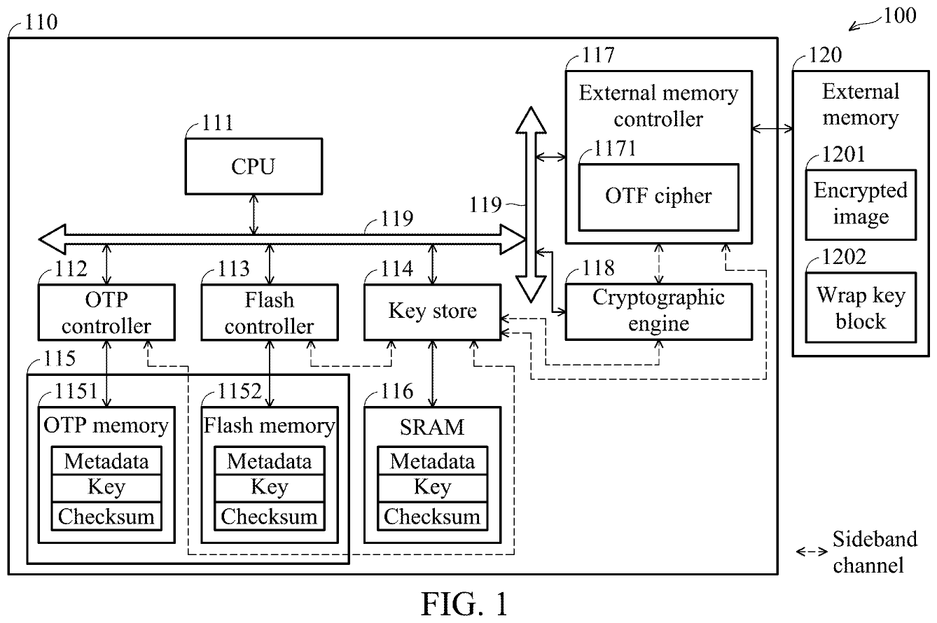

FIG. 1 is a schematic diagram illustrating a system 100 for protecting and managing keys according to an embodiment of the present disclosure. The system 100 at least comprises a device 110 for protecting and managing keys and an external memory 120, wherein the device 110 for protecting and managing keys may be a processor chip.

The device 110 comprises at least a central processing unit (CPU) (or microprocessor) 111, a one-time programmable (OTP) controller 112, a flash controller 113, a key store 114, an internal memory 115, a static random access memory (SRAM) 116, an external memory controller 117, and a cryptographic engine 118. The internal memory 115 comprises an OTP memory 1151 and a flash memory 1152, wherein the OTP memory 1151 and the flash memory 1152 respectively have metadata, a key, and a checksum. The SRAM 116 also comprises metadata, keys, and checksums. The external memory controller 117 at least comprises an on-the-fly (OTF) cipher 1171.

The external memory 120 at least comprises an encrypted image 1201 and a wrap key block 1202.

In the system 100, the CPU 111 communicates with the OTP controller 112, the flash controller 113, the key store 114, the external memory controller 117 and the cryptographic engine 118 through the bus 119, as shown in the solid line in FIG. 1. The OTP controller 112, the flash controller 113, the key storage circuit 114, the internal memory 115, the SRAM 116, the external memory controller 117 and the cryptographic engine 118 are communicated with each other using sideband signals through sideband channels (shown in dashed lines in FIG. 1), but not through the buses 119.

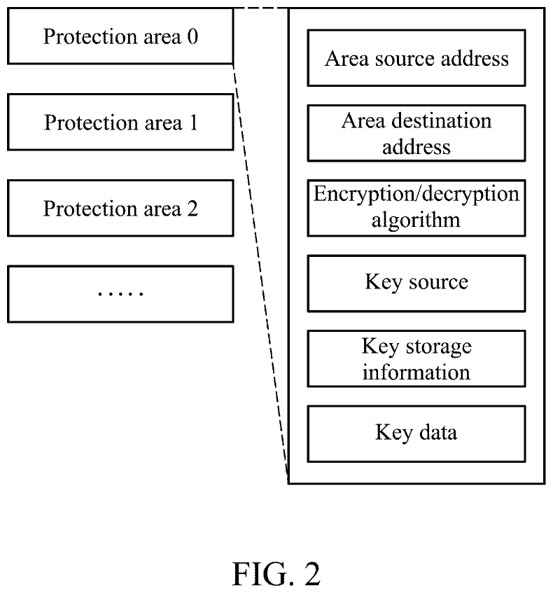

FIG. 2 is a schematic diagram of protection areas according to an embodiment of the present disclosure with reference to FIG. 1. The OTF cipher 1171 in the external memory controller 117 may provide a plurality of protection areas (Protection area 0, Protection area 1, Protection area 2, . . . ) for the user to set. Each protection area at least comprises an area source address, an area destination address, an encryption/decryption algorithm, a key source, key storage information and key data. The area source address and the area destination address may be used to determine the range of data to be encrypted. The key storage information comprises the information required by the key store, so that the OTF cipher may know where the key is obtained from. In addition, the user may freely decide whether different protection areas are protected by different encryption and decryption algorithms, for example, the advanced encryption standard (AES) algorithm or the CHACHA encryption and decryption algorithm. The user may also choose whether the key source is provided by the CPU 111 or by the key store 114, wherein the key store 114 may subdivide the key source into the SRAM 116 and the internal memory 115 (comprising the OTP memory 1151 and the flash memory 1152) or the external memory 120.

It should be noted that the protection areas are located in the OTF cipher 1171 of the external memory controller 117. The cryptographic engine 118 may only obtain the key data in the protected areas, and the key store 114 may only store the key data and read the key storage information in the protected areas.

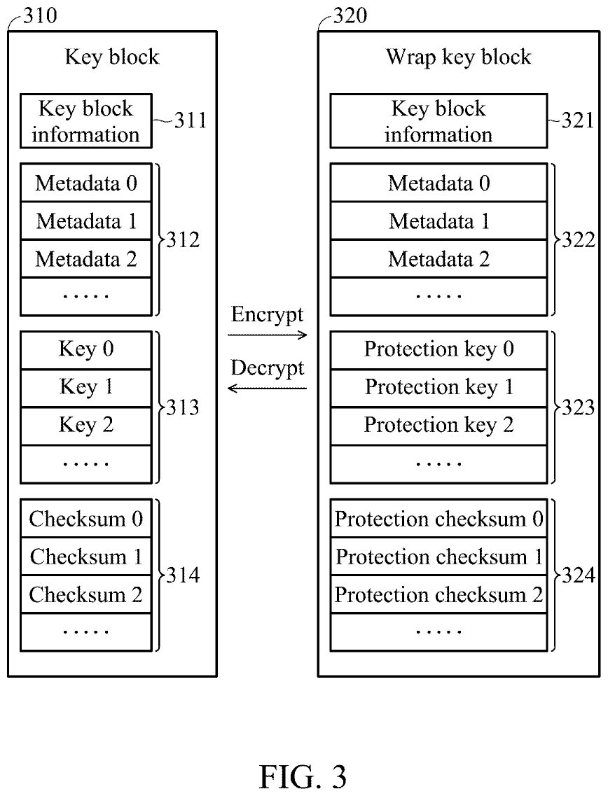

When the key is stored in the external memory 120, the key store adopts a key block structure, as shown in FIG. 3. The key block 310 has four blocks, namely key block information 311, metadata 312 (comprising Metadata 0, Metadata 1, Metadata 2, . . . ), and key 313 (comprising Key 0, Key 1, Key 2, . . . ) and checksum 314 (comprising Checksum 0, Checksum 1, Checksum 2, . . . ).

The key block information 311 at least comprises information such as the number of keys stored in the external memory, the initial address of the metadata, the initial address of the key, the initial address of the checksum, etc., which is helpful for the key store 114 to be able to quickly access to the key information located in external memory at the initial stage. The metadata, keys and checksums must be placed in sequence according to the key number sequence, so that the key store 114 may quickly find the content of the key and use the checksum to confirm the correctness of the data when reading the key.

Attribute fields of the metadata 312 may include key size, owner, security level, privilege level, readable attribute, revoke attribute and the booting state, and so on; however, the present disclosure is not limited to the examples described herein. The content of each field of the metadata will be described in the following paragraphs.

The key size indicates the length of a key and may be expressed by an amount of bits of the key, such as 80 bits, 128 bits, or 256 bits. According to the different encryption/decryption algorithm, the encryption/decryption device 180 can support a key size in a range of 64 bits to 4096 bits.

The owner attribute indicates an owner of a key, and the user not owning the key is unable to read the key. A key owner can be set according to different requirements, for example, a key owner can be set as CPU, AES, HMAC, ECC and RSA.

The security-level attribute indicates a security level of a key, and, for example, may be classified into a secure level and a non-secure level. The key with the secure level can be used by the owner with the same secure level, and it is not necessary to check the security level of the owner for the key with the non-secure level. It should be noted that the security-level attribute in the metadata of the key must be in cooperation with the CPU to be effective. For example, the CPU may be classified into a secure processor or a non-secure processor, and the field setting of the security level of the metadata of the key can be effective when the CPU is a secure processor. When the CPU is a non-secure processor, the field setting of the security level of the metadata of the key is not effective.

The privilege-level attribute indicates a level of privilege of the key, and for example, may be classified into a privilege level and a non-privilege level. The key with privilege level may be used by the owner with the same privilege level, and the key with the non-privilege level does not need to check the level of the privilege of the owner. Different user may have different permissions, for example, an administrator or a super user has the highest privilege level and may access the key set with the privilege level; a general user not with the privilege level is unable to access the key with the privilege level.

The readable attribute indicates whether the key may be read by the CPU. For example, when the owner field of the key is CPU, it indicates that the key can be readable for the CPU. When the owner field of the key is other encryption/decryption circuit, the key store may determine whether the CPU may read the key according to the readable attribute of the key.

The revoke attribute is recorded in an internal register of the key store, and unable to be set when the key is created. For example, in a general use condition, the key store can set the revoke attribute of the key as 0, and it indicates that this key can be used normally. When the user executes a key delete operation, the key store possibly deletes the key stored in the flash memory or the OTP memory; however, the key stored in the flash memory or the OTP memory may be unable to be actually deleted because of the setting of the lock bit. Therefore, when the key store performs the key delete operation, the key store sets the revoke attribute corresponding to the to-be-deleted key in the internal register, and after the revoke attribute corresponding to the to-be-deleted key in the key store is set, it is unable to modify the revoke attribute, and the key corresponding to the revoke attribute cannot be recovered to the usable state. At this time, no matter whether the condition of any other attribute is met, the key store is unable to read or use the key, of which the revoke attribute is set already, and it indicates that the revoke attribute of the key takes precedence over other attributes.

The booting state attribute indicates the booting state in which the key can be used, and for example, the booting states can be classified into a first booting state BL1 and a second booting state BL2. For example, when the booting state of the device 110 is in the first booting state BL1, the key store can use the key with the attributes of the first booting state BL1 and the second booting state BL2. When the booting state of the device 110 is in the second booting state BL2, the key store can use the key with the attribute of the booting state BL2.

After the protection areas are set by the user, the user may perform the encryption and decryption on the important data in the external memory through the OTF cipher structure. As shown in FIG. 1, the external memory 120 comprises two parts, an encrypted image 1201 and a wrap key block 1202. The generation of the encrypted image 1201 mainly consists of two steps. Step 1, the cryptographic engine 118 uses the key 313 to generate a key stream. Step 2, the cryptographic engine 118 transmits the key stream to the external memory controller 117 and performs an exclusive OR (XOR) operation on the important data to generate the encrypted image 1201. As for the part of the wrap key block 1202, the wrap key must first be transmitted to the internal memory 115 (the OTP memory 1151 and the flash memory 1152) through the key store 114. Next, the cryptographic engine 118 obtains the wrap key from the key store 114. Next, the key store 114 outputs the wrap key to the cryptographic engine 118 through the sideband signal. Finally, the cryptographic engine 118 performs key unwrap in a key wrapping algorithm on the wrap key and the key block to generate the wrap key block. As shown in FIG. 3, the wrap key block 320 comprises the key block information 321, the metadata 322 (comprising Metadata 0, Metadata 1, Metadata 2, . . . ), the protection keys 323 (comprising Protection key 0, Protection key 1, Protection key 2, . . . ) and the protection checksums 324 (comprising Protection checksum 0, Protection checksum 1, Protection checksum 2, . . . ).

When the encrypted image 1201 and the wrap key block 1202 already exist in the external memory 120, the OTF cipher 1171 must obtain the encryption key before reading the encrypted image 1201. When the OTF cipher 1171 does not have the encryption key, the OTF cipher 1171 sends a request message to the cryptographic engine 118 to request that the cryptographic engine 118 obtain the wrap key from the key store 114. Next, the OTF cipher 1171 may request that the key store 114 read the wrap key block from the external memory controller 117 through the sideband signal. The OTF cipher 1171 transmits the wrap key block to the cryptographic engine 118 to decrypt and restore the data format as shown in FIG. 2, and send the data format back to the key store 114 to confirm whether the key is consistent with the checksum. When the key store 114 confirms that the key is consistent with the checksum, the OTF cipher 1171 stores the encryption key in the corresponding protection area according to the key number. Next, the external memory controller 117 reads the encrypted image 1201, and the OTF cipher 1171 drives the cryptographic engine 118 to generate a key stream using the encryption key. Finally, the OTF cipher 1171 transmits the key stream to the external memory controller 117 to perform an exclusive OR (XOR) operation to obtain the original protection data. The encryption key may be stored not only in the external memory 120 but also in the internal memory 115 in advance. As shown in FIG. 1, in the OTP memory 1151 and the flash memory 1152, the metadata, the key and the checksum are included as a set of keys. The OTF cipher 1171 may store the key in the internal memory 115 or the SRAM 116 through the key store 114.

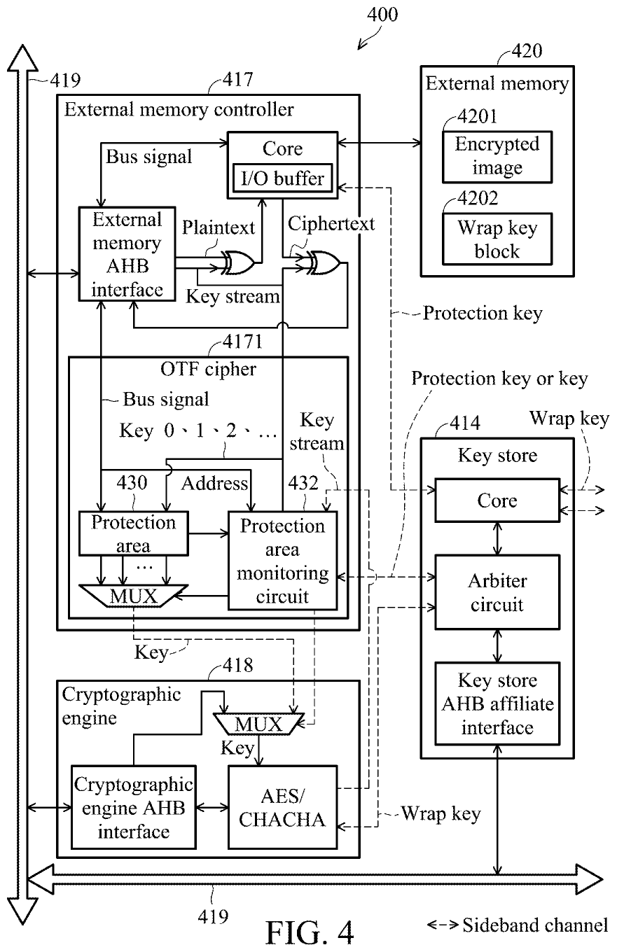

Next, referring to FIG. 4, FIG. 4 is another functional block diagram showing a partial OTP structure 400 of the system for protecting and managing keys according to an embodiment of the present disclosure. In FIG. 4, the OTP structure 400 may comprise an external memory controller 417, a cryptographic engine 418, a key store 414 and an external memory 420, wherein the external memory controller 417 comprises an OTF cipher 4171. In this OTF structure 400, the external memory controller 417, the cryptographic engine 418, the key store 414, and the external memory 420 are communicated with each other using sideband signals through sideband channels (shown in dashed lines in FIG. 4), but not through the buses 419.

The key store 414 includes a core, an arbitration circuit and an AHB

(Advanced High-Performance Bus) auxiliary interface of the key store. In the key store 414, except for the AHB auxiliary interface of the key store, the core and the arbitration circuit set independent sideband signals with the cryptographic engine 418 and the OTF cipher 4171, so there may be multiple service requests transmitted to the key store 414 at the same time. Since the core in the key store 414 may only process one of the service requests at a time, the arbitration circuit is required to determine the processing priority.

AHB is a bus architecture in system chip design under ARM AMBA architecture. The external memory controller 417, the cryptographic engine 418, and key store 414 built under the ARM AMBA architecture communicate with each other and transfer data through the AHB protocol. Therefore, the key store 414 must be responsible for processing the AHB protocol through the AHB auxiliary interface of the key store to communicate with the hardware in the external ARM AMBA architecture. The CPU may set the key store 414 through the AHB auxiliary interface of the key store to complete specific service requirements.

The cryptographic engine 418 may run the advanced encryption standard (AES) algorithm or the CHACHA encryption/decryption algorithm, and may generate a key stream using the encryption key or perform a key wrapping algorithm using the wrap key. The key store 414 centrally manages all keys, receives requests from the cryptographic engine 418 and the OTF cipher 4171, and accesses protection keys, wrap keys, and related materials from the SRAM, the flash memory, the OTP memory or the external memory 420. The external memory 420 is used for storing encrypted data. In addition to burning the ciphertext encrypted by the key stream into the external memory 420 and sending the decrypted plaintext to the bus 419, the external memory controller 417 may also receive requests from the key store 414 and read the wrap key block 4202.

The wrap key block 4202 is the result of wrapping the key using the NIST 800-38F manner. The user must first burn the wrap key into the internal memory (the OTP memory or the flash memory) through the key store. Then, the user sets the cryptographic engine to get the wrap key from the key store. Next, the key store outputs the wrap key to the cryptographic engine through the sideband signal to create a key stream. Finally, the cryptographic engine performs an exclusive OR (XOR) operation on the key stream and key blocks to generate the wrap key block 4202. The wrap key block 4202 is shown as the wrap key block 320 of FIG. 3.

The cryptographic engine 418 processes the AHB protocol through the AHB auxiliary interface of the cryptographic engine. The CPU may set the cryptographic engine 418 through the AHB auxiliary interface of the cryptographic engine to complete specific service requirements.

The OTF cipher 4171 may comprise a protection area 430 and a protection area monitoring circuit 432. The protection area monitoring circuit 432 is mainly responsible for detecting whether the address accessed by the external memory controller 417 is within the protection range of the protection area 430. When the address is within a specific protection area, the OTF cipher 4171 first checks whether the encryption key exists in the protection area 430, and then determines whether to drive the key store 414 or the cryptographic engine 418 to perform subsequent operations.

The multiplexer in FIG. 4 is a component that may use a selection signal to determine an input signal from multiple digital input signals for output. Therefore, the OTF cipher 4171 may provide with a selection signal through the protection area monitoring circuit 432. The multiplexer (MUX) of the OTF cipher 4171 uses the selection signal to determine which protection area information to output to the cryptographic engine 418. In addition, the cryptographic engine 418 also provides with a selection signal through the protection area monitoring circuit 432. Then, the multiplexer (MUX) of the cryptographic engine 418 uses the selection signal to determine whether AES/CHACHA executes the service request from the AHB auxiliary interface of the cryptographic engine or the OTF cipher 4171.

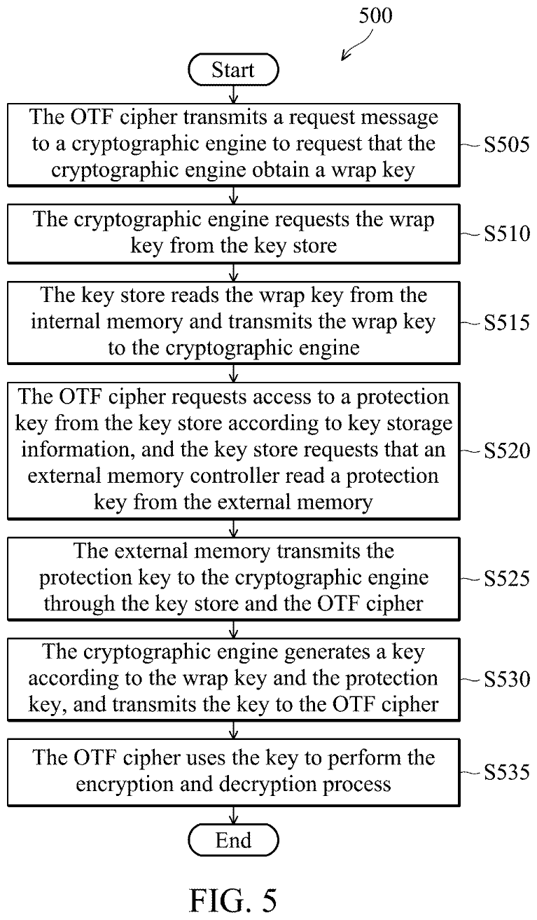

FIG. 5 shows a flowchart 500 of a method for protecting and managing keys according to an embodiment of the present disclosure. The method of FIG. 5 may be implemented in the system 100 for protecting and managing keys as shown in FIG. 1 and in the OTF structure 400 as shown in FIG. 4.

Before the process starts, the user has set the protection areas through the external memory controller bus interface. When the protection area monitoring circuit detects that the external memory controller is accessing the protection areas and the OTF cipher determines that the key is located in the external memory, the following steps will be executed.

In step S505, the OTF cipher transmits a request message to a cryptographic engine to request that the cryptographic engine obtain a wrap key. Then, in step S510, the cryptographic engine requests the wrap key from the key store.

Next, in step S515, the key store reads the wrap key from the internal memory and transmits the wrap key to the cryptographic engine. In one embodiment, the cryptographic engine receives the wrap key, stores the wrap key, and sends a notification message to the OTF cipher to notify that the cryptographic engine has obtained the wrap key.

In step S520, the OTF cipher requests access to a protection key from the key store according to key storage information, and the key store requests that an external memory controller read a protection key from the external memory. In one embodiment, the key storage information is stored in a plurality of protected areas in the OTF cipher, wherein each of the protected areas at least comprises: an area source address, an area destination address, an encryption/decryption algorithm, a key source, key storage information, and key data.

In step S525, the external memory transmits the protection key to the cryptographic engine through the key store and the OTF cipher. More specifically, the external memory first transmits the protection key to the key store, and the key store transmits the protection key to the OTF cipher. The OTF cipher receives the protection key and then transmits the protection key to the cryptographic engine.

In step S530, the cryptographic engine generates a key according to the wrap key and the protection key, and transmits the key to the OTF cipher. More specifically, the cryptographic engine performs a key wrapping algorithm on the wrap key and the protection key to generate the key. Finally, in step S535, the OTF cipher uses the key to perform the encryption and decryption process.

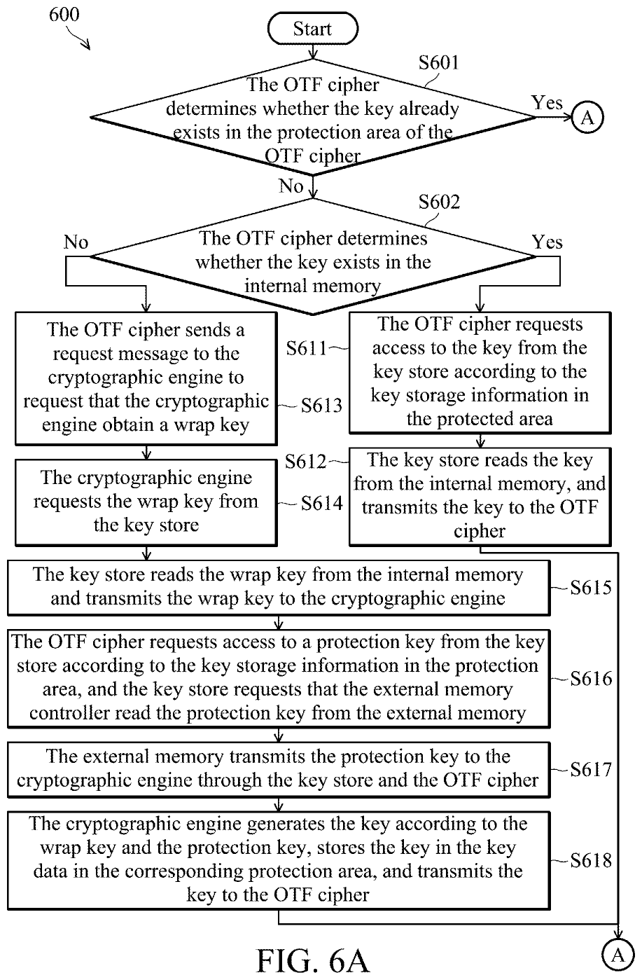

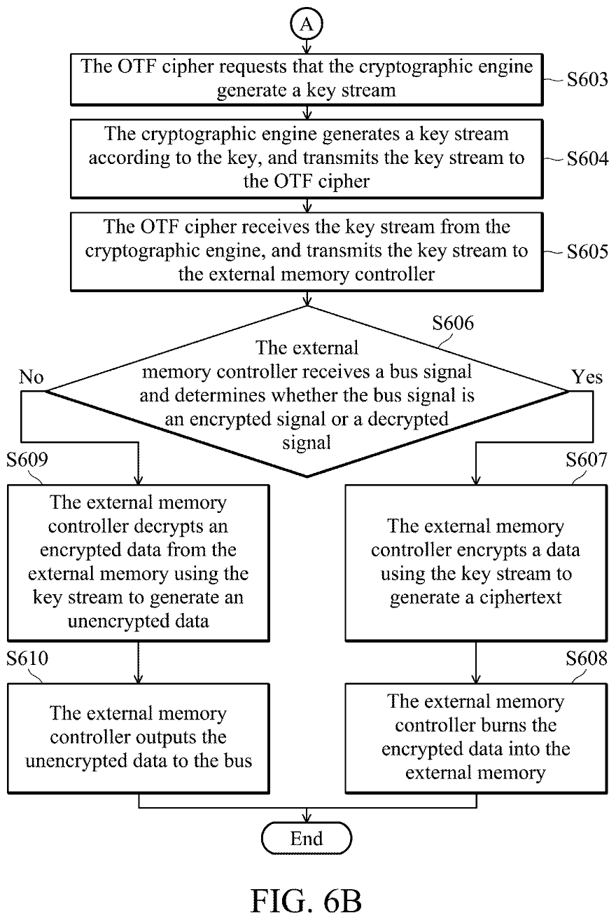

FIGS. 6A-6B show a flowchart 600 of a method for protecting and managing keys according to an embodiment of the present disclosure. The method of FIGS. 6A-6B may be implemented in the system 100 for protecting and managing keys as shown in FIG. 1 and the OTF structure 400 as shown in FIG. 4. The flowchart 600 further describes the situation where the key already exists in the OTF cipher or in the internal memory.

Before the process starts, the user has set the protection areas through the external memory controller bus interface. When the protection area monitoring circuit detects that the external memory controller is accessing the protection area and the OTF cipher determines that the key is located in the external memory, the following steps will be executed.

First, in step S601, the OTF cipher determines whether the key already exists in the protection area of the OTF cipher. It should be noted that the key source may be set to the protected area through the CPU or provided by the key store.

When the key already exists in the protection area of the OTF cipher (“Yes” in step S601), in step S603, the OTF cipher requests that the cryptographic engine generate a key stream. Then, in step S604, the cryptographic engine generates a key stream according to the key, and transmits the key stream to the OTF cipher. In step S605, the OTF cipher receives the key stream from the cryptographic engine, and transmits the key stream to the external memory controller.

In step S606, the external memory controller receives a bus signal and determines whether the bus signal is an encrypted signal or a decrypted signal. When the bus signal is an encrypted signal (“Yes” in step S606), in step S607, the external memory controller encrypts a data using the key stream to generate a ciphertext. More specifically, the external memory controller may perform an XOR operation on the key stream and the data (or plaintext) to generate an encrypted data (or ciphertext). Finally, in step S608, the external memory controller burns the encrypted data into the external memory, and the process ends.

When the bus signal is a decrypted signal (“No” in step S606), in step S609, the external memory controller decrypts an encrypted data from the external memory using the key stream to generate an unencrypted data (plaintext). More specifically, the external memory controller performs an XOR operation on the key stream and the encrypted data (or ciphertext) from the encrypted image to generate an unencrypted data (or plaintext). Finally, in step S610, the external memory controller outputs the unencrypted data to the bus, and the process ends.

Returning to step S601, when the key does not exist in the protection area of the OTF cipher (“No” in step S601), in step S602, the OTF cipher determines whether the key exists in the internal memory. When the OTF cipher determines that the key is stored in the internal memory (“Yes” in step S602), in step S611, the OTF cipher requests access to the key from the key store according to the key storage information in the protected area. Next, in step S612, the key store reads the key from the internal memory, and transmits the key to the OTF cipher. The process then skips to step S603 and continues until the process ends.

Returning to step S602, when the OTF cipher determines that the key does not exist in the internal memory (“No” in step S602), in step S613, the OTF cipher sends a request message to the cryptographic engine to request that the cryptographic engine obtain a wrap key. Next, in step S614, the cryptographic engine requests the wrap key from the key store. In step S615, the key store reads the wrap key from the internal memory and transmits the wrap key to the cryptographic engine. In one embodiment, the cryptographic engine receives the wrap key, stores the wrap key, and sends a notification message to the OTF cipher to notify that the cryptographic engine has obtained the wrap key.

Next, in step S616, the OTF cipher requests access to a protection key from the key store according to the key storage information in the protection area, and the key store requests that the external memory controller read the protection key from the external memory. In step S617, the external memory transmits the protection key to the cryptographic engine through the key store and the OTF cipher. In step S618, the cryptographic engine generates the key according to the wrap key and the protection key, stores the key in the key data in the corresponding protection area, and transmits the key to the OTF cipher. The process then skips to step S603 and continues until the process ends.

In one embodiment, before the key is stored in the wrap key block of the external memory and the encrypted image in the external memory is decrypted, the user needs to write the initial address of the key block information in the key store in advance, and sets the key storage information in the protection area. When the key store is initialized, in addition to reading all the information of the metadata in the internal memory, the key store may also read the wrap key block of the external memory and store the blocks of the metadata to the key store to manage all keys. It should be noted that when the key store finishes storing all the keys, the key store may obtain the metadata and the checksums from the built-in memory of the key store, recalculate the checksums of the keys and check whether each key is consistent with the corresponding checksum. When a key is consistent with the corresponding checksum, the key store may output the key.

In summary, the present disclosure may provide the following advantages:

1. The sources of the keys are rich. The key may be decrypted from the external memory and recorded in the key store; the key may be from the internal memory and managed by the key store; the user may set the protection area of the key through the external memory controller.

2. The cryptographic engine uses the AES algorithm or the CHACHA encryption and decryption algorithm.

3. The OTF cipher may execute on-the-fly encryption and decryption.

4. The external memory, the OTF cipher, the cryptographic engine, the external memory controller, and the key store communicate with each other through sideband signals. Therefore, attackers cannot obtain important data (e.g., keys) by controlling the CPU.

5. The external memory, the OTF cipher, the cryptographic engine, the external memory controller and the key store may process the tasks assigned by the CPU when the decryption process is not performed.

Therefore, a method and device for protecting and managing keys provided in the present disclosure may securely send the encrypted data in the external memory to the chip system for decryption, and ensure that the key used for decryption cannot be stolen, so as to achieve the purpose of quickly and effectively protecting the important confidential information in the external memory.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the disclosure has been described by way of example and in terms of exemplary embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A method for protecting and managing keys, used in a device, comprising:
transmitting, by an on-the-fly (OTF) cipher, a request message to a cryptographic engine to request that the cryptographic engine obtain a wrap key when a key is located in an external memory;
requesting, by the cryptographic engine, the wrap key from a key store;
reading, by the key store, the wrap key from an internal memory and transmitting the wrap key to the cryptographic engine;
requesting, by the OTF cipher, access to a protection key from the key store according to key storage information, and the key store requests that an external memory controller read the protection key from the external memory;
transmitting, by the external memory, the protection key to the cryptographic engine through the key store and the OTF cipher;
generating, by the cryptographic engine, the key according to the wrap key and the protection key and transmitting the key to the OTF cipher; and
using, by the OTF cipher, the key to perform an encryption and decryption process.

2. The method for protecting and managing keys as claimed in claim 1, wherein the method further comprises:
requesting, by the OTF cipher, access the key from the key store according to the key storage information when the key is not located in the external memory but is located in the internal memory; and
reading, by the key store, the key from the internal memory, and transmitting the key to the OTF cipher, so that the OTF cipher uses the key to perform the encryption and decryption process.

3. The method for protecting and managing keys as claimed in claim 1, wherein the method further comprises:
requesting, by the OTF cipher, that the cryptographic engine generate a key stream according to the key;
generating, by the cryptographic engine, the key stream according to the key and transmitting the key stream to the OTF cipher; and
transmitting, by the OTF cipher, the key stream to the external memory controller.

4. The method for protecting and managing keys as claimed in claim 3, wherein the method further comprises:
encrypting, by the external memory controller, data using the key stream to generate encrypted data when the external memory controller receives an encrypted signal; and
storing, by the external memory controller, the encrypted data in the external memory.

5. The method for protecting and managing keys as claimed in claim 1, wherein the external memory, the OTF cipher, the cryptographic engine, the external memory controller, and the key store communicate with each other through sideband signals.

6. A device for protecting and managing keys, comprising:
an external memory controller, comprising:
an on-the-fly (OTF) cipher;
a cryptographic engine, coupled to the external memory controller;
a key store, coupled to the external memory controller and the cryptographic engine; and
an internal memory, coupled to the key store;
wherein when a key is located in an external memory, the OTF cipher transmits a request message to the cryptographic engine to request that the cryptographic engine obtain a wrap key; the cryptographic engine requests the wrap key from the key store; the key store reads the wrap key from the internal memory and transmits the wrap key to the cryptographic engine; the OTF cipher requests access to a protection key from the key store according to key storage information, and the key store requests that the external memory controller read the protection key from the external memory; the external memory transmits the protection key to the cryptographic engine through the key store and the OTF cipher; the cryptographic engine generates the key according to the wrap key and the protection key and transmits the key to the OTF cipher; and the OTF cipher uses the key to perform an encryption and decryption process.

7. The device for protecting and managing keys as claimed in claim 6, wherein the OTF cipher and the key store further execute the following steps:
the OTF cipher requests access to the key from the key store according to the key storage information when the key is not located in the external memory but is located in the internal memory; and
the key store reads the key from the internal memory, and transmits the key to the OTF cipher, so that the OTF cipher uses the key to perform the encryption and decryption process.

8. The device for protecting and managing keys as claimed in claim 6, wherein the key storage information is stored in a plurality of protection areas in the OTF cipher.

9. The device for protecting and managing keys as claimed in claim 6, wherein the cryptographic engine uses an advanced encryption standard (AES) algorithm or a CHACHA encryption/decryption algorithm.

10. The device for protecting and managing keys as claimed in claim 6, wherein the step of generating the key by the cryptographic engine according to the protection key further comprises:
the cryptographic engine executes a key wrapping algorithm on the wrap key and the protection key to generate the key.
